(19) United States
(12) Patent Application Publication
(10) Pub. No.: US 2009/0231140 A1
(43) Pub. Date: Sep. 17, 2009

(54) RADIO FREQUENCY IDENTIFICATION ANTENNA AND APPARATUS FOR MANAGING ITEMS USING THE SAME

(75) Inventors: Jin-Kuk HONG, Gyeonggi-Do (KR); Jae-Yul CHOO, Gyeonggi-Do (KR); Jeong-Ki RYOO, Daejeon (KR)

Correspondence Address: GREENBLUM & BERNSTEIN, P.L.C., 1950 ROLAND CLARKE PLACE, RESTON, VA, 20191, US

(73) Assignee: LS INDUSTRIAL SYSTEMS CO., LTD., Gyeonggi-Do (KR)

(21) Appl. No.: 12/364,704

(22) Filed: Feb. 3, 2009

(30) Foreign Application Priority Data
Feb. 5, 2008 (KR) 10-2008-0011838

(51) Int. Cl. G08B 13/14; H01Q 1/22; H01Q 1/50; H01Q 1/38

(52) U.S. Cl. 340/572.7; 343/720; 343/860; 343/700 MS

(57) ABSTRACT

Disclosed are a radio frequency identification (RFID) reader antenna using an RFID technique and an apparatus for managing items using the same, the antenna comprising: a feeding portion having one end connected to an RFID reader and another end connected to a ground; and a conductive radiating electrode disposed above the feeding portion by being spaced apart from the feeding portion by a certain distance and configured to send or receive a signal of a certain band to/from an RFID tag attached to each item by an electromagnetic coupling with the feeding portion.

### RELATED APPLICATION

The present disclosure relates to subject matter contained in priority Korean Application No. 10-2008-011838, filed on Feb. 5, 2008, which is herein expressly incorporated by reference in its entirety.

### BACKGROUND OF THE INVENTION

1. Field of the Invention

The present invention relates to a radio frequency identification (RFID) reader antenna and an apparatus for managing items using the same, and particularly, to an RFID antenna for a shelf using an ultra-high frequency (UHF) band signal and an apparatus for managing items using the same.

2. Background of the Invention

In general, a radio frequency identification (RFID) technique denotes contactlessly reading out data stored in tags, labels, cards, and the like, each having a compact semiconductor chip by using a wireless (radio) frequency signal.

Such RFID technique is implemented such that information related to items and their peripheral circumstances are identified from tags attached on such items by using a wireless frequency signal, which allows collection, storage, processing and tracing of information on each item, resulting in enabling various services, including location measuring of the items, remote control for the items, management of the items, information exchange between the items, and the like.

The RFID technique has recently been employed to manage items, such as stock of items, warehousing/delivering of items and selling of items. In particular, by using the RFID technique, an RFID antenna is installed on an item managing shelf and tags are attached to each item, so as to be aware of the current condition of each item in real time, whereby many items can efficiently be managed.

The RFID antenna using such mentioned technique and the apparatus for managing items using the RFID tags are disclosed in Japanese Laid-Open Publication No. 2007-70112. Hereinafter, with reference to FIGS. 1 and 2, description will be given of configurations of an RFID antenna and an apparatus for managing items using RFID tags disclosed in Japanese Laid-Open Publication No. 2007-70112.

FIG. 1 is a view showing a configuration of an apparatus for managing items using an RFID antenna according to the present invention.

As shown in FIG. 1, an apparatus 1 for managing items using an RFID antenna includes an RFID antenna 15 mounted inside a shelf board 11, and a converter 16 configured to exchange information, such as an electrical signal or the like, with the RFID antenna 15 and connected to an external computer (not shown) via an interface circuit (not shown).

Various shapes of items 17 are placed on the shelf board 11 with RFID tags 18 being attached thereto. The RFID tag 18 is provided with a small loop antenna and a memory having information recorded therein, and an electronic chip is disposed at the center of the loop antenna.

FIG. 2 is a view showing a detailed configuration of the related art RFID antenna for a shelf.

As shown in FIG. 2, the related art RFID antenna 15 is configured in a structure of two loop antennas 23 and 24 being stacked on each other. The RFID antenna 15 operates in a sequentially operating manner that one of the first or second antenna 23 or 24 first operates followed by the other one. Thus, in order to operate the two antennas 23 and 24 disposed on one shelf, a switching circuit is required for sequentially operating each of the antenna 23 and 24 at two RFID readers (not shown) or one RFID reader (not shown).

However, radiators (or emitters) of the related art loop antennas 23 and 24 for the shelf can be used only below a high frequency (HF) band (3 MHz˜30 MHz), for example, 13.56 MHz. Since an entire length of a radiator of the loop antenna of 13.56 MHz is relatively much shorter than a wavelength (1λ₀=22 m) of electric wave on the air, a phase change less occurs on a radiator line. Accordingly, strength and direction of a surface current of the radiator are constant, whereby a null point at which the wave is offset is less generated.

Hence, the related art has usually used antennas employing the aforementioned HF band (3 MHz˜30 MHz).

However, in recent time, markets are getting extended to an RFID application field using an ultra-high frequency (UHF) band (300 MHz˜3 GHz).

An RFID system of the UHF band enables the identification of tags even at a remote distance farther than a valid identification distance of 5 m, and also has very high identification speed and identification rate at a short distance nearer than 50 cm as compared to the HF band.

In the RFID system of the UHF band, a far field is usually formed as an electric field such that a tag identification is possible at a remote distance. However, it is operated by a backscattering, and thus is sensitive to its peripheral environment.

On the other hand, a near field in the RFID system of the UHF band is usually formed as a magnetic field and operated by a coupling. Thus, it is hardly affected by a material having high permittivity, such as water or metal, so as to provide high identification rate and fast identification speed of an RFIDI reader.

However, the antenna of the UHF band uses high operation frequency and short wavelength of an electric wave, thereby to frequently cause a null point at which a signal is not identified at the near field as compared to the antenna of HF band, from the perspective of its physical feature.

Furthermore, for the antenna of the UHF band, if the number of items having tags attached thereto are increased, the operation frequency of the antenna is shifted. Accordingly, the RFID reader antenna may be affected by the change in the number of items.

### SUMMARY OF THE INVENTION

Therefore, an object of the present invention is to provide a radio frequency identification (RFID) antenna capable of avoiding a generation of a null point at a near field even using a UHF-band frequency, and an apparatus for managing items using the same.

Another object of the present invention is to provide an RFID antenna capable of accurately obtaining information related to RFID tags using a UHF-band frequency even when many items exist or items are massed, and an apparatus for managing items capable of easily identifying a current condition of each item using the same.

To achieve these and other advantages and in accordance with the purpose of the present invention, as embodied and broadly described herein, there is provided a radio frequency identification (RFID) reader antenna including: a feeding portion having one end connected to the RFID reader and another end connected to a ground; and a radiating electrode disposed to be spaced apart from the feeding portion and configured to send or receive a signal of a certain band.

The feeding portion and the radiating electrode may be formed inside a dielectric substance or on a surface thereof.

The feeding portion and the radiating electrode may be electromagnetically coupled to each other so as to send or receive a signal.

The antenna may further include a load resistance connected between the another end of the feeding portion and the ground.

The feeding portion may be disposed below the radiating electrode.

The antenna may further include an antenna port connected at the one end of the feeding portion.

The antenna may further include a sub electrode disposed to be spaced apart from the feeding portion by a certain distance.

The antenna may further include a sub resistance connected between one end of the sub electrode and the ground and configured to control an impedance matching.

The sub electrode may be disposed in parallel with the feeding portion on the same surface.

The sub electrode may be configured as a linear feeding line or strip line including a conductive material.

The radiating electrode may be arranged perpendicular to the feeding portion at one end thereof, and arranged vertical to the sub electrode at another end thereof.

The certain band may be an ultra high frequency (UHF) band.

The radiating electrode may be configured in a shape of a meander.

The feeding portion may be at a shelf for storing items thereon.

In accordance with one embodiment of the present invention, there is provided an apparatus for managing items including: at least one shelf configured to store items thereon; at least one radio frequency identification (RFID) reader antenna disposed at the shelf, and including a feeding portion having one end connected to an RFID reader and another end connected to a ground, and a conductive radiating electrode spaced apart from the feeding portion by a certain distance for sending or receiving a signal of a certain band to/from an RFID tag attached to each item; and an RFID reader configured to receive information from the RFID tag attached to each item via the RFID reader antenna.

The radiating electrode may send or receive a UHF-band signal by an electromagnetic coupling with the feeding portion by being spaced apart therefrom by a certain distance.

The RFID reader antenna may be provided in plurality, and the apparatus may further include a switching portion configured to perform a switching operation such that the plurality of RFID reader antennas are sequentially connected to the RFID reader.

The RFID reader antenna may further include: a load resistance disposed between another end of the feeding portion and the ground and configured to allow a current applied from the RFID reader to smoothly flow all over the feeding portion; a sub electrode disposed on the same surface as the feeding portion by being spaced apart from the feeding portion by a certain distance and configured to process a signal of the certain band by a coupling with the feeding portion; and a sub resistance connected between the sub electrode and the ground and configured to control an impedance matching.

The RFID reader antenna may send or receive a UHF-band signal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a configuration of an apparatus for managing items using a related art RFID antenna;

FIG. 2 is a view showing a detailed configuration of the RFID antenna for a shelf according to the related art;

FIG. 3 is a perspective view of an RFID reader antenna according to the present invention;

FIG. 4 is an upper view of the RFID reader antenna according to the present invention;

FIG. 5 is a side view of the RFID reader antenna according to the present invention;

FIG. 6 is a view showing a magnetic field formed around a feeding portion according to the present invention;

FIGS. 7A and 7B are views showing a correlation between a magnetic field of the feeding portion and a magnetic field formed at adjacent RFID tags according to the present invention;

FIGS. 8A and 8b are views showing a comparison between an impedance bandwidth of only the feeding portion and an entire impedance bandwidth of the RFID antenna according to the present invention;

FIG. 9 is a perspective view showing an apparatus for managing items using an RFID reader antenna in accordance with an embodiment of the present invention; and

FIG. 10 is a view showing a configuration of the apparatus for managing items using the RFID reader antenna in accordance with the embodiment of the present invention.

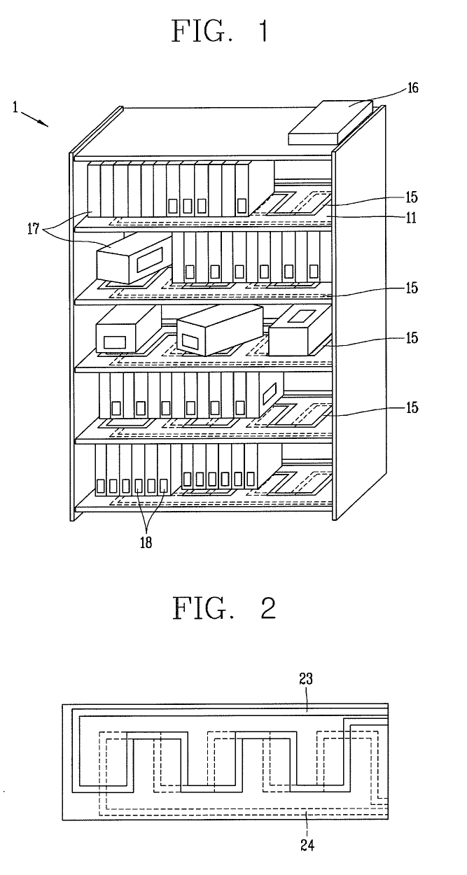

### DETAILED DESCRIPTION OF THE INVENTION

Description will now be given in detail of an RFID reader antenna and an apparatus for managing items using the same according to the present invention, with reference to the accompanying drawings.

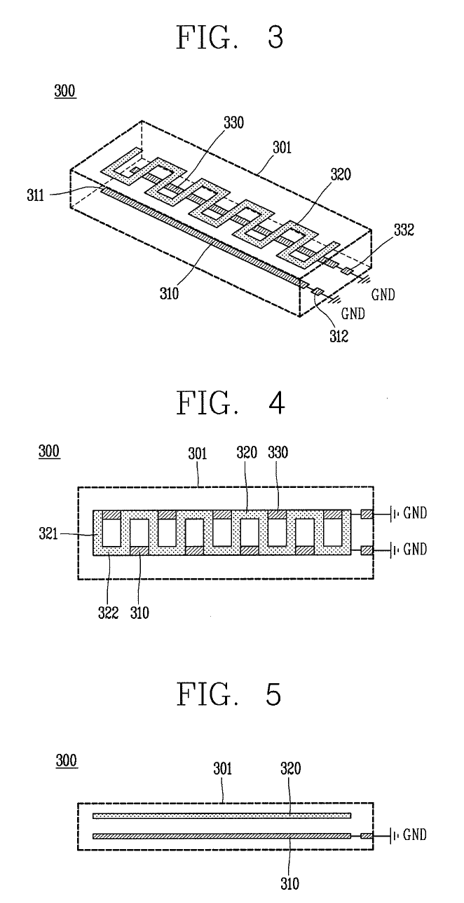

FIG. 3 is a perspective view of an RFID reader antenna 300 according to the present invention, FIG. 4 is an upper view of the RFID reader antenna 300, and FIG. 5 is a side view of the RFID reader antenna 300.

As shown in FIGS. 3 to 5, the RFID reader antenna 300 according to the present invention may include a feeding portion 310 formed at a lower portion of a dielectric substrate 301, and a radiating electrode 320 formed above the feeding portion 310. Here, the feeding portion 310 and the radiating electrode 320 may be made of a conductive material, and formed inside the dielectric substrate 301 or on the surface of the dielectric substrate 301.

The feeding portion 310 may be configured as a linear feeding line or strip line. An antenna port 311 through which a current is supplied is formed at one end of the feeding portion 310, and a load resistance 312 is connected to another end of the feeding portion 310. Also, the load resistance 312 is connected to a ground GND.

The radiating electrode 320 is formed above the feeding portion 310 by being perpendicularly spaced apart therefrom by a certain distance. The radiating electrode 320 is implemented by including a plurality of first electrodes 321 arranged in a direction orthogonal to the feeding portion 310, and a plurality of second electrodes 322 arranged in a direction in parallel with the feeding portion 310. One ends of the first and second electrodes 321 and 322 are alternately connected to each other, and thus, as shown in FIGS. 3 to 5, the radiating electrode 320 can substantially be configured in a shape of meander. Also, a type or size of the dielectric substance of the dielectric substrate 301 may determine a connected angle between the first and second electrodes 321 and 322, a distance between two adjacent first electrodes 321 or two adjacent second electrodes 322, and shapes of the first and second electrodes 321 and 322. The radiating electrode 320 is fed by an electromagnetic coupling with the feeding portion 310, which allows the antenna 300 to process frequencies of UHF band (i.e., 300 MHz˜3 GHz).

In addition, the present invention further provides a sub electrode 330, which is arranged on the same surface as the feeding portion 310 by being horizontally spaced apart from the feeding portion 310 by a certain distance. The sub electrode 330 may be arranged in parallel with the feeding portion 310 on the same surface, or be configured as a linear feeding line or strip line using a conductive material. The sub electrode 330 may be fed by an electromagnetic coupling with the feeding portion 310, so as to allow the antenna 300 to process frequencies of the UHF band (i.e., 300 MHz˜3 GHz).

One end of the sub electrode 330 is open and another end thereof is connected to a sub resistance 332. The sub resistance 332 is connected to the ground GND. The sub resistance 332 is used for an impedance matching of the antenna 300.

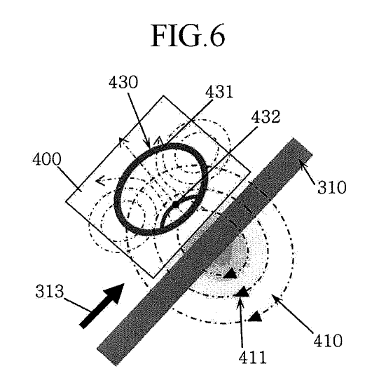

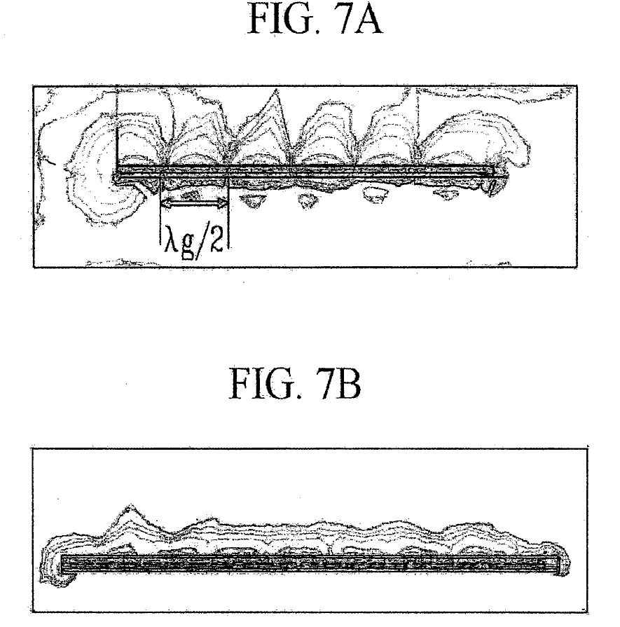

FIG. 6 is a view showing a magnetic field formed around a feeding portion according to the present invention, and FIGS. 7A and 7B are views showing a correlation between a magnetic field of the feeding portion and a magnetic field formed at adjacent RFID tags according to the present invention.

Hereinafter, an operation of the RFID reader antenna 300 according to the present invention will be described with reference to FIGS. 6, 7A and 7B.

First, a signal having a UHF-band frequency is input from an RFID reader (not shown) to the antenna port 311 of the feeding portion 310. The signal input to the antenna port 311 is applied to the entire feeding portion 310, thus to generate a magnetic field 410 around the feeding portion 310 as shown in FIG. 6. The magnetic field 410 is formed in a clockwise direction 411 around the feeding portion 310 in cooperation with a current flowing direction 313 according to Ampere's Law.

The magnetic field 410 generated around the feeding portion 310 is then applied to the RFID tag 430 attached to an item 400 placed at an adjacent position. Accordingly, the RFID reader (not shown) can contactlessly perform a wireless communication at a short distance with the RFID antenna 430 via the antenna 300. In FIG. 6, reference numeral ‘431’ denotes a tag antenna of the RFID tag 430, and ‘432’ denotes an electronic chip disposed in the RFID tag 430 for storing information.

FIG. 7A is a view showing a magnetic field formed around the feeding portion 310 when a current signal having a UHF-band frequency is applied to the feeding portion 310 in case of only the feeding portion 310 being provided according to the present invention.

As shown in FIG. 7A, when a physical length of the feeding portion 310 is long, a null point is generated by an interval of λ_{g}/2 (here, λ_{g} denotes a valid wavelength) according to a wavelength of a signal applied. However, at such null point, even if the RFID tag 430 is located near the feeding portion 310, a case that the RFID reader (not shown) does not identify the RFID tag 430 may occur.

FIG. 7B is a view showing a magnetic field formed around the feeding portion 310, the radiating electrode 320 and the sub electrode 330 when a current signal having a UHF-band frequency is applied to the feeding portion 310 in case of the feeding portion 310, the radiating electrode 320 and the sub electrode 330 being provided.

As shown in FIG. 7B, when the radiating electrode 320 is disposed above the feeding portion 310 according to the present invention and the sub electrode 330 is also disposed in parallel with a side surface of the feeding portion 310, it can be noticed that the null point generated around the RFID reader antenna 300 is removed, as shown in the comparison of FIG. 7B, due to the affection of a parasitic capacitance by the radiating electrode 320 and the sub electrode 330.

That is, with the configuration according to the present invention, a vector component of the magnetic field is changed by an electromagnetic coupling between the feeding portion 310 and the radiating electrode 320 or an electromagnetic coupling between the feeding portion 310 and the sub electrode 330, so as to enable a reduction or complete removal of the null point.

In particular, with the configuration according to the present invention, the null point can be removed by the electromagnetic coupling between the feeding portion 310 and the radiating electrode 320. Also, when the sub electrode 330 is further disposed at the feeding portion 310 and the radiating electrode 320, the null point can further be reduced.

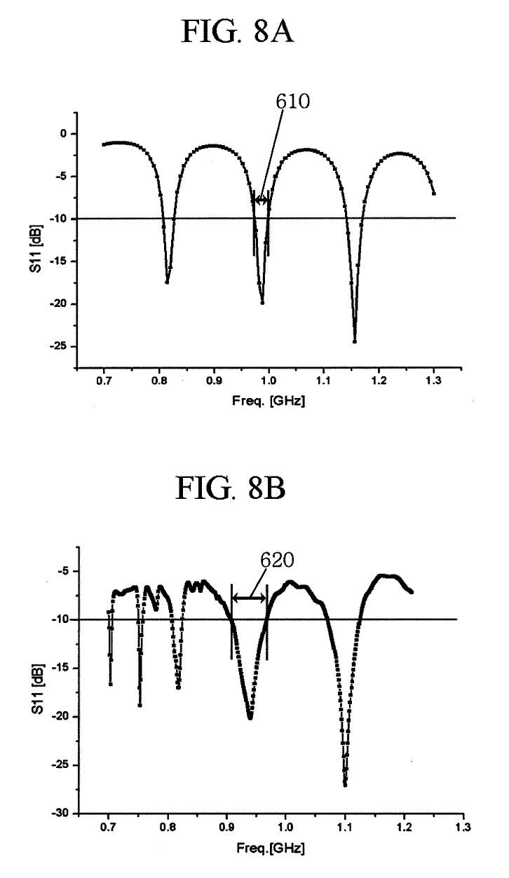

FIG. 8 is a view showing a comparison between an impedance bandwidth of only the feeding portion and an entire impedance bandwidth of the RFID antenna according to the present invention.

FIG. 8A shows an impedance bandwidth when only the feeding portion 310 is configured. As shown in FIG. 8A, it can be seen that a narrow bandwidth 610 is represented when only the feeding portion 310 is disposed.

On the other hand, FIG. 8B shows an impedance bandwidth when the feeding portion 310, the radiating electrode 320 and the sub electrode 330 are all disposed. As shown in FIG. 8B, it can be seen that an impedance bandwidth 620 is increased about three times wider than that when the feeding point 310 is only disposed, in case where the radiating electrode 320 and the sub electrode 330 as well as the feeding portion 310 are all configured.

As such, the RFID reader antenna 300 according to the present invention can be implemented such that the impedance bandwidth can be increased by the electromagnetic coupling between the feeding portion 310 and the radiating electrode 320 and the electromagnetic coupling between the feeding portion 310 and the sub electrode 330, which means that the RFID reader antenna 300 is tolerant to the permittivity of an item located near its upper portion. Accordingly, the RFID reader antenna 300 and the RFID reader (not shown) using the antenna 300 can obtain a constant tag identification rate regardless of the number of items placed on the antenna 300 and the number of tags attached to the items.

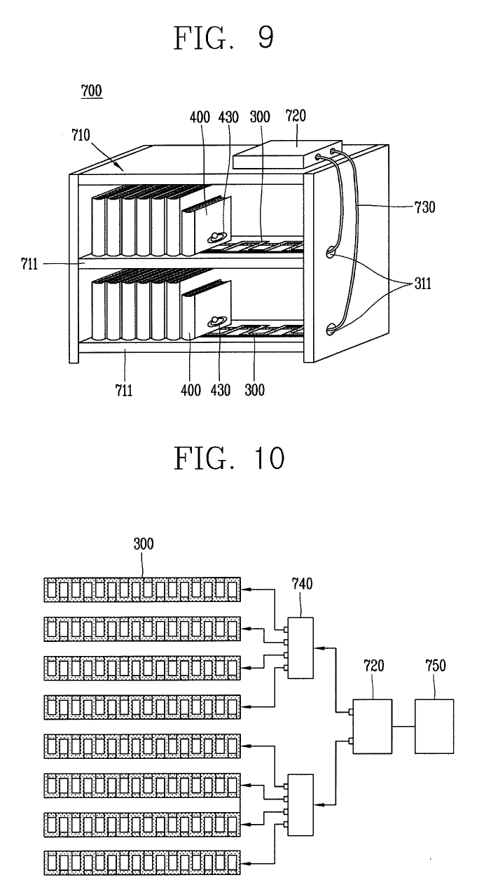

FIG. 9 is a perspective view showing an apparatus for managing items using an RFID reader antenna in accordance with an embodiment of the present invention, and FIG. 10 is a view showing a configuration of the apparatus for managing items using an RFID reader antenna in accordance with the embodiment of the present invention.

As shown in FIGS. 9 and 10, an apparatus 700 for managing items according to the present invention may include shelves 711 for keeping items 400 thereon, RFID reader antennas 300 each disposed on the shelves 711, and an RFID reader 720 for reading information out of the RFID tags 430 attached to the items 400 via the RFID reader antenna 300.

The shelf 711 is formed of a dielectric substance having a certain permittivity, and has the RFID reader antenna 300 according to the present invention disposed inside thereof or on an upper surface thereof. Also, the shelf 711 may be used as the dielectric substrate 311 according to the present invention. In this case, the feeding portion 310, the radiating electrode 320, the sub electrode 330, the load resistance 312, the sub resistance 332 and the like may be disposed inside the shelf 711 or on the upper surface of the shelf 711.

The shelf 711 may be disposed at various types of item storage cabinets 5 710, such as bookcases, bookracks or cabinets, which are divided into a plurality of spaces by the shelves 711 for keeping items on each space. For example, FIG. 9 shows a bookrack as the item storage cabinet 710, and also shows may books as the items 400 kept on the item storage cabinet 710.

As aforementioned with reference to FIGS. 3 to 8, the RFID reader antenna 300 includes the feeding portion 310, the radiating electrode 320, the sub electrode 330, the load resistance 312 and the sub resistance 332 and the like. Also, the RFID reader antenna 300 can obtain information from the RFID tags 430 using the UHF-band frequency at a short distance by the electromagnetic coupling, and also can remove the null point, even having a wide impedance bandwidth. Accordingly, the RFID reader antenna 300 can acquire a constant tag identification rate regardless of the number of items placed on the antenna 300 and the number of tags attached to the items.

The RFID reader 720 is connected to the antenna port 311 of the RFID reader antenna 300 via an antenna cable 730. The RIFD reader 730 then receives information from the RFID tags 430 attached to the items 400 via the RFID reader antenna 300 to transmit to an external server 750, thereby comprehensively managing the current condition of items via the server 750.

In addition, the apparatus 700 for managing items according to the present invention may further include a switch portion 740 connected to a plurality of RFID reader antennas 300 and one RFID reader 720. The switch portion 740 performs a switching operation such that the plurality of RFID reader antennas 300 can sequentially be connected to the RFID reader 720 when a plurality of shelves 711 are disposed on the item storage cabinet 710 and thus the plurality of RFID reader antennas 300 are provided.

Such configuration of the apparatus 700 for managing items can increase identification speed and identification rate of the RFID tags at a short distance by using the UHF-band frequency, at libraries, document repositories, warehouses, material management storages or the like, having many books and documents collected or many items stored. Also, the configuration of the apparatus 700 for managing items allows an accurate management of the current condition of each item without any affection by the number of items.

An RFID reader antenna according to the present invention is provided with a radiating electrode fed by an electromagnetic coupling with a feeding line via which a current is directly fed, so as to prevent the generation of a null point at a near field even using a UHF-band frequency.

The RFID reader antenna according to the present invention can accurately acquire information related to RFID tags without any change in a frequency using the UHF-band frequency even when many items are placed on the RFID antenna.

An apparatus for managing items according to the present invention can remarkably enhance identification speed and identification rate of items located at a near distance and also obtain a wide impedance bandwidth without a null point by employing the RFID reader antenna and using the UHF band frequency, so as to enable an accurate management of a current condition of each item regardless of the number of items.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An antenna for a radio frequency identification (RFID) reader comprising:
a feeding portion having one end connected to the RFID reader and another end connected to a ground; and
a radiating electrode disposed to be spaced apart from the feeding portion and configured to send or receive a signal of a certain band.

2. The antenna of claim 1, wherein the feeding portion and the radiating electrode are formed inside a dielectric substance or on a surface thereof.

3. The antenna of claim 1, wherein the feeding portion and the radiating electrode are electromagnetically coupled to each other so as to send or receive a signal.

4. The antenna of claim 1, further comprising a load resistance connected between the another end of the feeding portion and the ground.

5. The antenna of claim 1, wherein the feeding portion is disposed below the radiating electrode.

6. The antenna of claim 1, further comprising an antenna port connected at the one end of the feeding portion.

7. The antenna of claim 1, further comprising a sub electrode disposed to be spaced apart from the feeding portion by a certain distance.

8. The antenna of claim 7, further comprising a sub resistance connected between one end of the sub electrode and the ground and configured to control an impedance matching.

9. The antenna of claim 7, wherein the sub electrode is disposed in parallel with the feeding portion on the same surface.

10. The antenna of claim 9, wherein the sub electrode is configured as a linear feeding line or strip line including a conductive material.

11. The antenna of claim 5, wherein the radiating electrode is arranged perpendicular to the feeding portion at one end thereof, and vertical to the sub electrode at another end thereof.

12. The antenna of claim 1, wherein the certain band is an ultra high frequency (UHF) band.

13. The antenna of claim 1, wherein the radiating electrode is configured in a shape of a meander.

14. The antenna of claim 1, wherein the feeding portion is in a shelf for storing items thereon.

15. An apparatus for managing items comprising:
at least one shelf configured to store items thereon;
at least one radio frequency identification (RFID) reader antenna disposed at the shelf, and including a feeding portion having one end connected to an RFID reader and another end connected to a ground, and a conductive radiating electrode spaced apart from the feeding portion by a certain distance for sending or receiving a signal of a certain band to/from an RFID tag attached to each item; and
an RFID reader configured to receive information from the RFID tag attached to each item via the RFID reader antenna.

16. The apparatus of claim 15, wherein the radiating electrode sends or receives a UHF-band signal by an electromagnetic coupling with the feeding portion by being spaced apart therefrom by a certain distance.

17. The apparatus of claim 15, wherein the RFID reader antenna is provided in plurality,
wherein the apparatus further comprises a switching portion configured to perform a switching operation such that the plurality of RFID reader antennas are sequentially connected to the RFID reader.

18. The apparatus of claim 15, wherein the RFID reader antenna further comprises:
a load resistance disposed between another end of the feeding portion and the ground and configured to allow a current applied from the RFID reader to smoothly flow all over the feeding portion;
a sub electrode disposed on the same surface as the feeding portion by being spaced apart from the feeding portion by a certain distance and configured to process a signal of the certain band by a coupling with the feeding portion; and
a sub resistance connected between the sub electrode and the ground and configured to control an impedance matching.

19. The apparatus of claim 15, wherein the RFID reader antenna sends or receives a UHF-band signal.
